(19) United States
(12) Patent Application Publication
(10) Pub. No.: US 2025/0178241 A1
(43) Pub. Date: Jun. 5, 2025

(54) DEVICE AND METHOD FOR PROCESSING MATERIALS

(71) Applicant: EREMA Engineering Recycling Maschinen und Anlagen Gesellschaft m.b.H., Ansfelden (AT)

(72) Inventor: Sebastian SOCHOR, Niederneukirchen (AT)

(73) Assignee: EREMA Engineering Recycling Maschinen und Anlagen Gesellschaft m.b.H., Ansfelden (AT)

(21) Appl. No.: 18/837,537

(22) PCT Filed: Feb. 8, 2023
(86) PCT No.: PCT/AT2023/060036

§ 371 Date: Aug. 9, 2024

(30) Foreign Application Priority Data
Feb. 11, 2022 (AT) A50088/2022

(51) Int. Cl. B29B 17/04; B29B 7/42; B29B 7/84; B29B 9/06; B29B 17/02

(52) U.S. Cl. CPC B29B 17/04; B29B 7/429; B29B 7/845; B29B 9/06; B29B 17/02; B29B 2017/048

(57) ABSTRACT

The invention relates to a device and a method for processing materials that contain or consist of polymer materials, in particular for processing, during recycling, soiled thermoplastic polymers. The device comprises an extruder (2) having a screw (10) for melting the materials, also having a first filtering unit (3) for filtering the melt and a degassing zone (5) for degassing the melt. According to the invention, a melt pump (6) is connected, at the extruder outlet (9), to the degassing zone (5) or after or downstream of the screw (10).

The invention relates to a device and a method for processing materials containing or consisting of polymer materials or for recycling processing of contaminated thermoplastic polymers according to the preamble of claim 1 or rather 19.

When processing secondary raw materials, a well-known and proven sequence of steps consists of extrusion, filtration, and granulation of the thermoplastic materials to be processed.

A known advantageous concept is to first heat or soften the thermoplastic polymers in a cutter-compactor or preconditioning unit (PCU), then transfer them to an extruder and melt them there, then filter and degas the melt, possibly filter it again, and then produce granules, for example. The first melt filtration is here arranged before or rather upstream of the extruder degassing. This enables end products of good quality and a high proportion of regranulates to be produced.

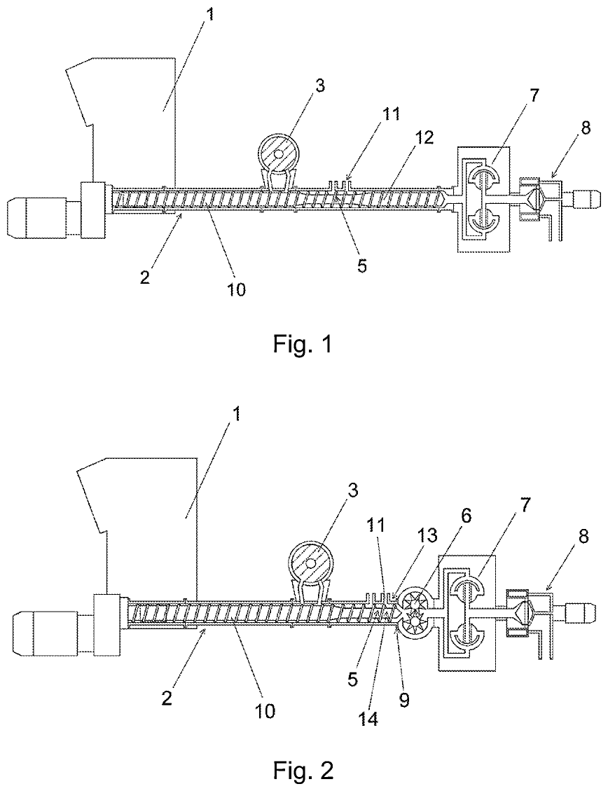

A known device or procedure provides, for example, the following: In a cutter-compactor or preconditioning unit (PCU), the polymer material to be treated is crushed, mixed, heated, dried, pre-compacted, and, if necessary, buffered. An extruder directly tangentially connected to the cutter-compactor is continuously filled with the heated and softened pre-compacted material. The material is plasticized in the extruder screw. The melt is discharged from the extruder at the end of the plasticizing zone, cleaned in an automatic, self-cleaning filter, and returned to the section of the extruder downstream of the filter. In this section of the extruder, i.e., after the first melt filter, the melt undergoes final homogenization. In the subsequent degassing zone, the filtered and homogenized melt is degassed. The melt is then fed to the respective tool, e.g., a granulating device, via the discharge zone of the extruder. Optionally, a second melt filtration can also be arranged behind the discharge zone and in front of the tool. Such a device is shown, for example, in FIG. 1, and is described in greater detail below.

Due to such filtration, homogenization, and degassing, materials that are difficult to process, such as highly printed foils and/or moist materials, can also be processed.

However, it is shown that even with a single filtration step, but especially when two filtration steps are provided or rather used, the pressure increases in the melt and the melt temperature can be very high, especially at the end of the extrusion system, particularly upstream of the tool.

Particularly when recycling polymers, a two-step filtration or double filtration is often used, which can be necessary especially when recycling more heavily contaminated polymers, in order to remove, for example, contaminants and gels that require different separation methods under various circumstances from the material flow to be processed. This quality-enhancing cleaning is consistently associated with an increase in pressure. High melt temperatures are generated in the case of an extruder, especially when the pressure is generated only with melt.

However, high mass or melt temperatures lead to a negative impact on the quality of the polymers. High mass or melt temperatures cause, among other things, a higher consumption of stabilizers, a shortening of the molecular chains, an undesirable gel formation, or even a burning of particles and polymer in the melt. The decomposition of the polymer or of ingredients is also promoted by high temperatures. As a result, a part of the efforts of the upstream processes to increase the material quality is reversed or counteracted.

From the state of the art, it is also generally known to provide the melt-transporting gear pumps in the region of the distal end of an extruder.

Therefore, the object of the present invention is to create a device and a method with which the resulting material quality can be easily improved.

The invention solves this task in a device for processing materials containing or consisting of polymeric materials, in particular for the recycling processing of contaminated thermoplastic polymers, comprising at least one extruder having at least one screw for melting the materials, having at least one first filtration unit for filtering the melt and at least one degassing zone for degassing the melt, by the characterizing features of claim 1.

According to the invention, at least one melt pump or a device for pumping the polymer melt is connected or arranged or provided at the extruder outlet to the degassing zone or after or downstream of the screw.

This means accordingly that the melt pump is arranged behind the extruder outlet or downstream of the extruder or the screw and thus necessarily also behind or downstream of the degassing zone. Therefore, the melt pump connects to the degassing zone in the direction of the flow of the melt. The arrangement of the melt pump can be directly behind the degassing zone or indirectly behind it, i.e., at a certain distance behind the degassing zone.

By such an arrangement of the melt pump, a pressure increase is achieved with simultaneous reduction of the mass temperature, which reduces the aforementioned disadvantages and results in an improved material quality.

The lower mass temperature in this range has a correspondingly positive effect on the melt quality. It is also advantageous to have a lower tendency to develop undesirable odors or discolorations that can occur more strongly in higher temperature systems, especially in applications with cellulose contaminants such as paper or wood. This is particularly advantageous when recycling typical supermarket films made of LDPE/LLDPE, for example, some of which have high residual moisture, especially when these films are contaminated with paper, e.g., from labels, wood particles from pallets, etc., or with foreign polymers, dust, etc. Here, even a temperature increase of just a few degrees has a particularly disruptive and disadvantageous effect.

This is particularly advantageous for difficult-to-treat polymer materials and if the application requires polymer-friendly processing and a strong filtration performance.

Through the downstream melt pump, the degassing can also achieve a particularly efficient and strong effective force, because there is a decoupling of pressure and temperature build-up. As a result, the highest temperature in the overall system does not only occur at the end of the screw or before the second filtration unit, but already prior to degassing. This counteracts a later gassing of melting components with positive effects on the quality of melt and regranulate.

The pressure build-up by the melt pump advantageously causes the extruder to be relieved of the pressure build-up task and this can be carried out significantly more quickly; therefore, making the device more compact and space-saving.

A further advantage of the pressure build-up by the melt pump is that the extruder speed-without loss of throughput—can be optimally adjusted to the polymer.

Furthermore, a lower mass temperature also lowers energy consumption considerably.

Furthermore, only cleaned and degassed melt flows through the melt pump, which represents an advantage for the service life of this component.

In this context, it is advantageous if the melt pump is spatially connected directly and immediately to the degassing zone in the conveying direction without any further functional unit in between, or is connected downstream of the degassing zone and coupled one after the other in terms of the process.

In this context, a “functional unit” is understood to be a unit that acts on the melt, e.g., mechanically, or causes a processing step.

The term “direct and immediate” is to be understood in the present case in such a way that the melt pump is arranged directly next to or behind the degassing zone and that no real processing units, such as filters, homogenizers, or the like, are provided between the melt pump and the degassing zone. Passive connection or transition elements or tubes do not interfere and may be present.

The direct and immediate arrangement of the melt pump downstream of degassing, instead of a pressure increase zone in the extruder or a discharge metering zone, results in an advantageous increase in the necessary pressure, for example for a possible additional filtration step.

It can also be advantageous if the extruder is in the downstream region of the first filter unit, in particular in the region downstream of the degassing zone is free of a metering zone that increases the pressure of the melt and/or that the melt pump replaces a metering zone. A screw extruder is relatively inefficient if it should increase pressure or pump melt. For this reason, it is also advantageous to omit the last pressure-increasing stage (metering zone) of an extruder after degassing, and in particular upstream of a second filtration, and to replace it with a melt pump.

Accordingly, the melt pump is coupled directly and immediately downstream of the degassing unit or degassing zone of the extrusion screw. Thus, the quality improvement achieved by filtration is not gained at the expense of or destroyed by excessively high mass temperatures.

Alternatively, it is also advantageous if the melt pump is not arranged directly behind the degassing zone, but if there is a certain distance between the degassing and the melt pump.

In this context, it is advantageous if the screw continues continuously in the area between the center of the rearmost degassing opening of the degassing zone, which is located furthest downstream in the conveying direction, and the extruder outlet, i.e., if there is a residual screw or conveying elements between the degassing and the melt pump. It is therefore advantageous to have a continuous screw from the inlet to the extruder outlet, i.e., on both sides of the degassing.

In this context, it is further advantageous if the melt pump is connected at a distance of a maximum of <=20 D from the degassing. Particularly advantageous is a certain minimum distance, i.e., that it is provided that the distance is in the range of 5 to 20 D, preferably in the range of 5 to 15 D, preferably in the range of 8 to 11 D.

D refers to the outer diameter of the screw of the extruder and measured at the furthest downstream opening of the degassing zone, which is furthest downstream of the direction of the flow, wherein at least one degassing opening is formed in the degassing zone.

The distance between the degassing opening and the melt pump mentioned here is defined in the present case as the distance measured between the center of the rearmost degassing opening of the degassing zone located furthest downstream in the conveying direction and the melt pump. In this case, particular attention is paid to the position of the active conveying element located furthest upstream or of the conveying-active parts of the melt pump located furthest upstream, i.e., to the beginning or the inlet-side passages of the melt pump, where the melt enters the pump or is captured by the conveying elements or the pumping effect. The distance is understood to be a “melt flow distance”, i.e., measured along or in the direction of the path that the melt travels or takes in the device or as a distance between the units along the conveying or flow direction of the melt.

A particularly advantageous device can be defined as follows:

A device for processing materials containing or consisting of polymeric materials, in particular for recycling processing of contaminated thermoplastic polymers, comprising an extruder (2) with a screw (10) for melting the materials, with a first filtration unit (3) for filtering the melt and a degassing zone (5) for degassing the melt,

wherein a melt pump (6) is connected at the extruder outlet (9) at or after the degassing zone (5) after or downstream of the screw (10), wherein the screw (10) also extends to the area between the center of the rear degassing opening (11) of the degassing zone (5), which is located farthest downstream, in the conveying direction and the extruder outlet (9) or a residual screw (14) or conveying elements are provided in this area, and wherein the melt pump (6) is connected at a distance (13) of 5 to 20 D, preferably in the range of 5 to 15 D, preferably in the range of 8 to 11 D, wherein D is the outer diameter of the screw (10) of the extruder (2) measured at the rearmost degassing opening (11) of the degassing zone (5) located furthest downstream in the conveying direction, and wherein the distance (13) is measured as the distance between the middle of the conveying direction at the furthest downstream rearmost degassing opening (11) of the degassing zone (5) and the melt pump (6), in particular the position of the furthest upstream active conveying element or the furthest upstream conveying active parts of the melt pump (6).

In this context, experiments have shown that the shortest screw downstream of degassing results in the lowest temperature increase. However, the conveying capacity of the screw is strongly influenced by the material fluctuations that occur during recycling. This can, for example, be caused by a backflow into the degassing zone and can even lead to material being discharged at the degassing opening. In addition to the loss of material, this also leads to a loss of degassing performance, which in turn leads to a reduced quality. Against this background, it is advantageous to provide a certain minimum length of the remaining screw, even if this leads to a certain mass temperature increase.

Recycling plants are designed to be highly universal in terms of their requirement profile and must be able to process different polymers with different viscosities and sliding properties. A minimum length of the discharge screw is also advantageous to ensure this universality.

Various experiments with different materials have shown that this makes it possible to achieve a universal design that combines operational safety and the lowest possible increase in temperature.

A device with the features mentioned above, in particular with the specified minimum distances, is thus flexible in its application on the one hand, but also very process-stable on the other hand and it achieves a particularly gentle treatment of the polymer melt through a low mass temperature. This increases the quality of the melt and the regranulate.

An advantageous embodiment provides in this context the ratio of the length of a first upstream section of the screw from the first filtration unit to the center of the most upstream front degassing opening of the degassing zone to the length of a second upstream section of the screw from the center of the most downstream rear degassing opening of the degassing zone to the end of the screw or to the extruder outlet, i.e., to the length of the remaining screw, is in the range from 0.1 to 3, in particular in the range from 0.3 to 2.

It is advantageous if the length of the first upstream section of the screw between the first filtration unit and the most upstream front degassing opening of the degassing zone is located in the range of 1 to 15 D, in particular in the range of 3 to 10 D.

Furthermore, it is advantageous if the length of the second upstream section of the screw between the furthest downstream rearmost vent opening of the vent zone and the extruder outlet, or the length of the remaining screw, is in the range of 3 to 12 D, in particular in the range of 4 to 10 D, preferably in the range of 5 to 8 D.

According to the aforementioned advantageous embodiments, the melt pump does not necessarily have to be immediately and directly connected to the degassing zone in the conveying direction without any further functional unit connected between them, but the aforementioned distance can be provided. Advantageously, the screw of the extruder or the remaining screw also continues in this area after the degassing zone.

In this context, it is advantageous if the inner core cross-section of the screw or remaining screw-namely in the area between the center of the rearmost degassing opening of the degassing zone located furthest downstream in the conveying direction and the extruder outlet—i.e., up to the end of the extruder screw—is increased or reduced by <=50%, preferably by <=20%, in particular by <=5%, and preferably remains constant. The smaller the change in the core cross-section, e.g., the compression, the less shear is introduced into the material. If the core cross-section increases too much, it will result in compaction of the material and it would lead to an undesirable increase in temperature. For certain materials, a small compaction may be useful, e.g., if there is a larger amount of substances to be degassed.

According to an advantageous embodiment, it is further provided that the slope of the screw or the remaining screw—in the area between the center of the rearmost degassing opening of the degassing zone located furthest downstream in the conveying direction and the extruder outlet-increases or decreases by <=3 L/D, preferably by 1.5<=L/D, in particular by <=0.5 L/D, and preferably remains constant. L/D refers to the usual ratio of the (active) length of the screw to the diameter of the screw. The smaller the change in slope, the less shear is introduced into the material. If the melt has a very high gas ballast, a small compaction can “squeeze” the material, i.e., push gas back into the degassing.

Furthermore, it is advantageous if the screw or the remaining screw is designed in such a way that the product consists of depth, web width, thread width and thread slope of the screw, i.e.,
P=d*w*W*S, whereby W=S-g*w
with
d . . . depth
w . . . Web width
W . . . Thread width
S . . . (Thread) slope
g . . . Number of threads of the screw

in the area between the center of the rear degassing outlet of the degassing zone and the extruder outlet located most farthest downstream in the conveying direction changes by <=30%, preferably by <=15%, in particular by <=5%, preferably by <=3%, in particular not at all. This can reduce the introduction of a shear into the material. A change in compression that is advantageous in certain cases can not only be achieved by changing the core cross-section, but also, for example, multiple threads, a change in slope or an increase in the web width leads to a certain increase in compaction.

A device with the last-mentioned features has not only the aforementioned advantages, in some cases also to an increased extent, but is also highly flexible in its application, but at the same time highly process-stable and achieves a particularly gentle treatment of the polymer melt. This increases the quality of the melt and the regranulate.

According to a further advantageous embodiment, it is provided that a second filtration unit is connected to the melt pump, in particular directly and immediately, without any further functional unit connected between them, in the conveying direction or downstream of the melt pump. Particularly when recycling heavily contaminated polymers, a two-step or double filtration is often required, for example, to remove contaminants or gels from the material flow to be prepared. This second filtration is always associated with an increase in pressure, whereby high melt temperatures are generated in the case of an extruder when the pressure generation is only carried out with the melt. The arrangement of the melt pump according to the invention is therefore particularly advantageous, particularly when a second filtration unit is provided. The melt pump therefore assumes the necessary pressure build-up for the second filtration unit. The extruder is relieved of this task and can therefore also be carried out more rapidly. This reduces the dwell time, the mass temperature and the energy consumption significantly.

A practically advantageous device is obtained if a discharge unit for discharge and/or at least one subsequent processing unit for processing the melt, for example a granulation unit, is provided, in particular downstream of a second filtering unit in the conveying direction.

It is also advantageous for the material quality if a container is provided for storing, in particular for crushing and/or heating, the materials to be processed, to which the extruder is connected. It is particularly advantageous if mixing and/or crushing tools are provided in the container for mixing and, if necessary, crushing the materials while permanently maintaining their lumpiness and flowability, and, if necessary, heating and softening the materials. A particularly advantageous embodiment provides that the container is a classic cutter-compactor or a PCU or preconditioning unit.

A particularly structurally advantageous device is characterized in that the extruder is a single-screw extruder with a single screw.

It is also advantageous if a gear pump is provided as a melt pump.

For better homogenization of the melt and for increasing the quality, it is advantageous if, in particular in the conveying direction after the first filtration unit and before the degassing zone, a homogenization unit for homogenizing the melt is provided, in particular a screw or a section of the screw or the extruder, which is designed in such a way, that the melt is sheared and mixed therein or is subjected to intensive shear stress and expansion stress and is strongly accelerated.

A device, which is particularly structurally advantageous, provides that at least the units of the extruder, the degassing zone and the melt pump, in particular all units provided for in the device, are arranged essentially linearly or axially one behind the other or are located along a common longitudinal axis.

However, according to the invention, a cascaded system is also possible, in which a first extruder melts the polymer material and the melt is also filtered there. The material is then transferred to a second extruder and degassed there. In this arrangement, the melt pump is arranged directly and immediately at the degassing zone of the second extruder.

The invention further solves the task set out above with a method for processing materials containing or consisting of polymeric materials, in particular for recycling processing of contaminated thermoplastic polymers, which comprises the following processing steps in the order given:
a) feeding of the materials to be processed, in particular in a container,
b) at least partially, in particular completely, melting of the materials, in particular in an extruder,
c) first filtration of the melt to release non-melted components and/or impurities,
d) degassing of the filtered melt,
e) increasing of the pressure of the melt by a melt pump,
f) discharge and/or subsequent processing of the melt.

According to the invention, it is provided that the increase in the pressure of the melt occurs after the degassing the melt or the degassing of the melt is downstream and coupled one after the other in the process.

Advantageously, a device having the features described above is used for this purpose.

As described above, the method according to the invention causes an increase in pressure of the melt while simultaneously reducing the mass temperature, thereby reducing the aforementioned disadvantages and leading to an improved material quality.

In this way, the advantages mentioned above are achieved with the method.

A further improved material quality is achieved in particular by homogenizing the filtered melt after the first filtration of the melt according to step c) and before degassing of the melt according to step d).

A second filtration of the melt is required especially for heavily contaminated polymers. Accordingly, it is advantageous if, after the increase in the pressure of the melt according to step e), a second filtration of the melt occurs, in particular directly and immediately, without any further intermediate processing step. However, if the melt is filtrated a second time, an increase in pressure is necessary and then there is a risk of an increasing mass temperature. In this case, it is therefore particularly advantageous to increase the pressure via the method according to the invention or via a melt pump.

A particularly advantageous preparation provides that the materials are crushed and/or heated before melting according to step b), in particular during step a), wherein it is preferably provided that the materials are heated and permanently mixed while maintaining their lumpiness and flowability, and optionally degassed, softened, dried, increased in viscosity, and/or crystallized.

It is particularly advantageous if at least the processing steps b), d), and e), in particular all provided processing steps, follow one another directly and immediately, in terms of time and space, each without any further processing step in between.

It is advantageous if there is a distance of <=20 D, in particular in the range from 5 to 20 D, preferably in the range from 5 to 15 D, preferably in the range from 8 to 11 D, between degassing and pressure increase, i.e., melt pump, where D is the outer diameter of the screw of the extruder used, measured at a rearmost degassing opening of a degassing zone located furthest downstream in the conveying direction, and where the distance is defined as the distance measured between the center of the rearmost degassing opening of the degassing zone located furthest downstream in the conveying direction and the melt pump, in particular the position of the furthest upstream active conveying element or the furthest upstream conveying active parts of the melt pump.

In this context, it is particularly advantageous if the inner core cross-section of the screw, the slope of the screw, and/or the product of depth, web width, thread width, and thread slope in the area between the center of the rearmost degassing opening of the degassing zone located furthest downstream in the conveying direction and the extruder outlet is designed according to the features of claim 6, 7, or 8, or are preferably as constant as possible.

The invention is now described using unrestricted exemplary embodiments.

FIG. 1 shows a device known from the prior art.

FIG. 2 shows a device according to the invention.

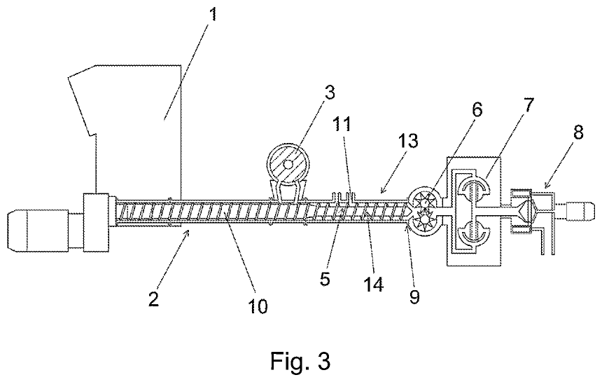

FIG. 3 shows a further device according to the invention.

FIG. 1 shows a device known from the prior art for comparison. This is a schematic diagram to illustrate the most important components and units of this device. Accordingly, this representation also does not claim the final accuracy of all constructive details and proportions.

FIG. 1 shows a container 1 in the form of a classic cutter-compactor or a preconditioning unit (PCU). In the present case, container 1 is filled from the left via a conveyor belt with the recycling polymer material to be processed. The polymer material is placed in container 1, crushed using mixing and crushing tools, mixed and heated until softened, but usually not melted. The chunkiness of the sticky polymer particles remains intact. In addition, the material undergoes a pretreatment and is, for example, dried, pre-compacted, and, depending on the material, the viscosity is increased.

An extruder 2 is connected tangentially in the lowest area of the cutter-compactor or container 1. The extruder 2 is a single screw extruder with a single screw 10. The material is discharged from the container 1 and transferred to the extruder 2 and there it is captured by screw 10. In the foremost section of the extruder 2, the material is melted and plasticized under increased pressure.

The melt is then filtered in a first filtration unit 3. The melt is discharged from the extruder 2 at the end of the plasticizing zone, cleaned in the automatic and self-cleaning first filtration unit 3 and then fed back into the section of the extruder 2 located downstream of the filtration unit 3.

Downstream and subsequent to the filter unit 3, a homogenization unit for homogenizing the melt can be provided. This may be a section of the extruder screw 10, which is designed such a way that the melt is sheared and mixed and subjected to intensive shearing and tensile stress.

Subsequently, the degassing zone 5 is arranged for degassing the melt. The extruder screw 10 has a reduced core diameter in this area, whereby the melt is relaxed or the pressure is reduced. There are two degassing openings 11 in the degassing zone 5, through which the escaping gas can escape.

Downstream of the degassing zone 5 is the discharge metering zone 12, in which the core diameter of the screw 10 increases again and the pressure on the melt is increased. This is necessary to prepare the melt for the discharge into the subsequent second filtration unit 7. However, this increase in pressure also increases the temperature of the melt, which has the previously mentioned adverse effects on the quality of the end products. Downstream of the second filtering unit 7, the molten material then enters the discharge unit 8 and can, if necessary, be further processed, for example by granulation.

In comparison to this, FIG. 2 shows a sketch of an exemplary device according to the invention. As in FIG. 1, this is a schematic overview representation that is not proportional and to scale and not illustrated down to the last detail.

The left part of the device according to FIG. 1 is essentially identical to the device according to FIG. 1, namely up to and including the degassing unit 5. In FIG. 2, however, the extruder screw 10 ends shortly after the degassing zone 5 and there is the extruder outlet 9.

Accordingly, only a short residual screw 14 is shown in FIG. 2 and the distance from the degassing zone 5 to the melt pump 6, here for example a gear pump, is short. The melt pump 6 continues to pump the melt and thus efficiently increases the pressure for the subsequent second filtration unit 7 which is provided analogous to FIG. 1. However, by providing the melt pump 6, the temperature of the melt does not increase excessively and both the temperature differences and the absolute melt temperatures remain lower.

The melt pump 6 is spatially connected to the extruder outlet 9 or to the degassing zone 5 via a short residual screw 14. The melt escaping from the extruder 2 or the degassing zone 5 accordingly passes via the residual screw 14 into the sphere of the melt pump 6 and is captured by the conveying components of the melt pump 6.

In order to ensure a transfer of the melt from the extruder 2 into the melt pump 6, it is possible to provide short passive transfer nozzles without deviating from the inventive concept, in particular also to compensate for differences in the diameters of the units. Such non-functional units do not affect the configuration according to the invention.

The distance 13 between the rearmost degassing opening 11 of the degassing zone 5 and the melt pump 6 is approximately 3 D in the exemplary embodiment according to FIG. 2. In view of the fact that the diameter of the screw 10 or the extruder 2 is shown increased for better representation, no real dimensions and ratios can be derived from FIG. 2, in particular not with regard to the distance 13.

In any case, the distance 13 is measured between the center of the degassing opening 11 which is the rearmost or furthest downstream when viewed in the conveying direction and the beginning of the melt pump 6, i.e., the furthest upstream, conveying-active parts of the melt pump 6. Therefore, the distance 13 comprises the length of the remaining screw 14 plus, if available, any passive adapter pieces, e.g., between the residual screw 14 and the melt pump 6. The outer diameter D of the screw 2 relevant for the distance 13 is taken or measured at the position of the rearmost degassing opening 11.

The screw 10 no longer changes from the rearmost degassing opening 11, i.e., the characteristics and geometries of the screw 10 or the remaining screw 14 remain unchanged up until the extruder outlet 9. In particular, the inner core cross-section and the slope of the screw 10 remain constant. The product of depth, web width, thread width, and slope also remains constant in the area from the rearmost degassing opening 11.

FIG. 3 shows a further embodiment according to the invention. This is also a schematic overview representation, not proportional and true to scale and not designed down to the last detail.

FIG. 3 shows a device analogous to FIG. 2; however, the length of the residual screw 14, i.e., the length of the screw 10 in the region downstream of the rearmost degassing opening 11, is somewhat longer, and thus the distance between the degassing zone 5 and the melt pump 6 is also greater than in the device according to FIG. 2.

In this embodiment, the length of the remaining screw 10 is shown in the region of the rearmost degassing opening 11, i.e., the remaining screw 14 is approximately 7 D. The distance 13 between the center of the rearmost degassing opening 11 of the degassing zone 5, which located furthest in the conveying direction, and the melt pump 6 is approximately 10 D (both not shown to scale).

D is always the outer diameter of the screw 10 of the extruder 2 measured at the rearmost degassing opening 11 of the degassing zone 5, which is located furthest downstream in the conveying direction.

The slope of the residual screw 14 downstream of the degassing opening 11 is constant about 1 L/D and thus the same as at the point of the degassing opening 11. Therefore, the slope of the screw 10 remains constant in the area between the center of the rear degassing opening 11 located furthest downstream in the conveying direction and the extruder outlet 9.

The inner core cross-section or the depth of the screw 10 is also substantially constant in the region between the center of the rearmost degassing opening 11 located furthest downstream in the conveying direction and the extruder outlet 9.

The embodiment according to FIG. 3 is a very universal design, i.e., it can be used for different polymers and advantageously combines stability and operational safety as well as a small increase in temperature, and it delivers a high quality of the end products.

Comparative tests:

The following comparative tests were carried out on various system configurations, namely on a system configuration 1 analogous to FIG. 1 (comparison) and on system configurations 2 with melt pump analogous to FIG. 2 or 3. The process parameters as well as the input materials were kept constant. LLD-PE films or HD-PE films from post-consumer waste were processed as material.

System Configuration 1-Comparison (without Melt Pump):

This is a PCU/extruder combination “Intarema 1108 TVE”:

| | Device type designation | Comment |
|---|---|---|
| Process unit | Intarema 1108 TVE | Container diameter 1100 mm; |
| | | Extruder diameter 80 mm |
| Melt filter 1 | LF 2/350 | Filtration 120 μm |
| Melt filter 2 | RTF 4/134 | Filtration 150 μm |
| Granulation | HG 154 D | Perforated plate 20 × 3 |

| | Extruder screw |
|---|---|
| Diameter D [mm] | 79.8 |
| Slope S [mm] | 80 |
| Web width w [mm] | 8 |
| Active screw length L | 42 × D |

System Configurations 2-According to the Invention with Melt Pump;

This is the same PCU/extruder combination “Intarema 1108 TVE”. However, a melt pump was arranged downstream of degassing at the extruder outlet, namely at the following intervals to the rearmost degassing opening (as defined above):
SP_V0: approx. 3 D
SP_V1: approx. 8 D
SP_V2: approx. 10 D
SP_V3: approx. 12 D

In the area behind or downstream of the degassing, the extruder screw or remaining screw continued, namely up close to the melt pump.

| | Device type | Comment |
|---|---|---|
| Process unit | Intarema 1108 TVE | Container diameter 1100 mm; |
| | | Extruder diameter 80 mm |
| Melt filter 1 | LF 2/350 | Filtration 120 μm |
| Melt pump | SP 45 | Maag |
| Melt filter 2 | RTF 4/134 | Filtration 150 μm |
| Granulation | HG 154 D | Perforated plate 20 × 3 |

| | Extruder screw | Extruder screw | Extruder screw | Extruder screw |
|---|---|---|---|---|
| | SP_V0 | SP_V1 | SP_V2 | SP_V3 |
| Diameter D [mm] | 79.8 | 79.8 | 79.8 | 79.8 |
| Slope S [mm] | 80 | 80 | 80 | 80 |
| Web width w [mm] | 8 | 8 | 8 | 8 |
| Active screw length L | 25 × D | 30 × D | 32 × D | 34 × D |
| Variable compression | | — | — | 1.3 × D |

### Result:

The mass temperature T1 was compared directly upstream of the 1st melt filter (LF) with mass temperature T2 directly upstream of the granulation (HG) downstream the 2nd melt filter. Furthermore, any material loss was assessed via degassing.

| | | [° C.] | [° C.] | [° C.] | [° C.] | |
|---|---|---|---|---|---|---|
| | [kg/h] | T1 mass temp. | T2 mass temp. | delta mass | Mean delta | Melt outlet |
| LLD-PE foil | Throughput | before LF | before HG | temp. | mass temp. | degassing |
| SP_V0 | 300-335 | 239 | 246 | 7 | 8.0 | little |
| | 370-390 | 240 | 249 | 9 | | a lot |
| | 340-370 | 241 | 249 | 8 | | a lot |
| SP_V1 | 320-370 | 245 | 255 | 10 | 10.0 | little |
| | 350-400 | 246 | 257 | 11 | | a lot |
| | 300-330 | 242 | 251 | 9 | | no |
| SP_V2 | 350-400 | 243 | 255 | 12 | 11.6 | no |
| | 300-350 | 245 | 256 | 11 | | no |
| | 340-380 | 242 | 254 | 12 | | no |
| SP_V3 | 330-360 | 239 | 252 | 15 | 15.3 | no |
| | 365-385 | 244 | 257 | 21 | | no |
| | 360-380 | 242 | 255 | 20 | | no |
| Comparison | 290-340 | 235 | 263 | 39 | 39 | no |
| of system | 290-330 | 237 | 261 | 35 | | no |
| configuration 1 | 350-400 | 227 | 260 | 43 | | no |

| | | [° C.] | [° C.] | [° C.] | [° C.] | |
|---|---|---|---|---|---|---|
| | [kg/h] | T1 mass temp. | T2 mass temp. | Delta mass | Mean delta | Melt outlet |
| HD-PE foil | Throughput | before LF | before HG | temp. | mass temp. | degassing |
| SP_V0 | 278-286 | 252 | 270 | 18 | 19 | little |
| | 320 | 255 | 275 | 20 | | a lot |
| SP_V1 | 250-300 | 253 | 280 | 27 | 26.5 | no |
| | 290-320 | 255 | 281 | 26 | | no |
| SP_V2 | 270-320 | 256 | 284 | 28 | 28.5 | no |
| | 260-300 | 254 | 283 | 29 | | no |
| SP_V3 | 250-300 | 253 | 288 | 35 | 34.0 | no |
| | 260-300 | 255 | 288 | 33 | | no |
| Comparison | 270-330 | 258 | 301 | 43 | 43.5 | no |
| system | 300-350 | 256 | 300 | 44 | | no |

It can be seen that in the configurations 2 according to the invention, the lower temperature increases were recorded (lowest in SP_V0) and furthermore it can be seen that the absolute temperatures were also lower—in each case compared to the system in the configuration 1 without melt pump.

It has also been shown that the shortest screw downstream of degassing (SP_V0) brings the lowest increase in temperature. However, the conveying capacity of the screw is strongly influenced by the material fluctuations that occur during recycling. This is shown, for example, by a material backflow into the degassing zone, which leads to a material discharge during the degassing opening and, in addition to the loss of material, also to a loss of the degassing capacity. As a result, this leads to reduced quality of the end products.

Therefore, a certain minimum length of the remaining screw was accepted here, even if this leads to a mass temperature increase.

In order to ensure the required universality of recycling systems, i.e., the ability to process different polymers with different viscosities and sliding properties, a certain minimum length of the discharge screw behind the degassing is therefore advantageous.

From the various experiments with different materials, version SP_V2 has proven to be the most universal design, which advantageously combines operational safety and the lowest temperature increase.

1. A device for processing materials containing or consisting of polymer materials, in particular for the recycling processing of contaminated thermoplastic polymers, comprising an extruder (2) with a screw (10) for melting the materials, with a first filtration unit (3) for filtration of the melt and a degassing zone (5) for degassing the melt, characterized in that at the extruder outlet (9), a melt pump (6) is connected to the degassing zone (5) or after or downstream from the screw (10).

2. The device according to claim 1, characterized in that the melt pump (6) is connected immediately and directly in the conveying direction to the degassing zone (5), without any further functional unit connected in between, or is connected downstream of the degassing zone (5) and is coupled one after the other in accordance with the process.

3. The device according to claim 1, characterized in that the melt pump (6) is connected at a distance (13) of <=20 D, in particular in the range of 5 to 20 D, preferably in the range of 5 to 15 D, preferably in the range of 8 to 11 D, wherein D is the outer diameter of the screw (10) of the extruder (2) measured at the rearmost degassing opening (11) of the degassing zone (5) located furthest downstream in the conveying direction, and where the distance (13) is defined as the distance measured between the center of the rearmost degassing opening (11) of the degassing zone (5) located furthest downstream in the conveying direction and the melt pump (6), in particular the position of the active conveying element located furthest upstream or of the active conveying parts of the melt pump (6) located furthest upstream.

4. The device according to claim 1, characterized in that the extruder (2) is in the region downstream of the first filtering unit (3), in particular in the region downstream of the degassing zone (5), is free of a metering zone increasing the pressure of the melt, and/or that the melt pump (6) replaces a metering zone.

5. The device according to claim 1, characterized in that a second filtration unit (7) is connected to the melt pump (6), in particular spatially immediately and directly in the conveying direction, without any further functional unit connected in between said pump.

6. The device according to claim 1, characterized in that the inner core cross-section of the screw (10) remains preferably constant in the region between the center of the rearmost degassing opening (11) of the degassing zone (5) located furthest downstream in the conveying direction and the extruder outlet (9), is increased or decreased by <=50%, preferably by <=20%, in particular by <=5%.

7. The device according to claim 1, characterized in that the slope of the screw (10), in the region between the center of the rear degassing opening (11) of the degassing zone (5) located furthest downstream in the conveying direction, and the extruder outlet (9), increases or decreases by <=3 L/D, preferably by 1.5<=L/D, in particular by <=0.5 L/D, and preferably remains constant.

8. The device according to claim 1, characterized in that the product consists of depth, web width, thread width and thread slope of the screw (10), namely
P=d*w*W*S, where W=S-g*w with
d . . . depth
w . . . Web width
W . . . Thread width
S . . . (Thread) slope
g . . . Number of threads of the screw in the area between the center of the rear degassing opening (11) of the degassing zone (5) and the extruder outlet (9) located most farthest downstream in the conveying direction changes by <=30%, preferably by <=15%, in particular by <=5%, preferably by <=3%, in particular not at all.

9. The device according to claim 1, characterized in that a discharge unit (8), in particular downstream of a second filtering unit (7) in the conveying direction, is provided for discharge and/or at least one reprocessing unit (8) for processing the melt, for example a granulation unit.

10. The device according to claim 1, characterized in that a container (1) can be provided for storing, in particular for crushing and/or heating, the materials to be processed, to which the extruder (2) is connected, and that it is preferably provided mixing and/or crushing tools in the container (1) for mixing and, if necessary, crushing the materials while permanently maintaining their lumpiness and flowability, and, if necessary, heating and softening of the materials, wherein the container (1) is preferably a cutter-compactor.

11. The device according to claim 1, characterized in that the extruder (2) is a single screw extruder with one single screw (10).

12. The device according to claim 1, characterized in that a gear pump is provided as a melt pump (6).

13. The device according to claim 1, characterized in that, in particular in the conveying direction downstream of the first filtration unit (3) and upstream of the degassing zone (5), a homogenization unit for homogenizing the melt is provided, in particular a screw or a section of the screw (10) or the extruder (2), which is designed in such a way, that the melt is sheared and mixed therein or is subjected to intensive shearing stress and tensile stress and is strongly accelerated.

14. The device according to claim 1, characterized in that the units (2), (5), and (6), in particular all units (2) to (8), if present, are arranged axially one behind the other or lie on a common longitudinal axis.

15. The device according to claim 1, characterized in that the screw (10) also continues in the area between the center of the rearmost degassing opening (11) of the degassing zone (5) and the extruder outlet (9), located furthest downstream, or a remaining screw (14) or conveying elements are provided in this area, and that the melt pump (6) is connected at a distance (13) of 5 to 20 D, preferably in the range of 5 to 15 D, preferably in the range of 8 to 11 D, where D is the outer diameter of the screw (10) of the extruder (2) measured at the rearmost degassing opening (11) of the degassing zone (5) located furthest downstream in the conveying direction, and where the distance (13) is measured as the distance between the center of the rearmost degassing opening (11) of the degassing zone (5) located furthest downstream in the conveying direction and the melt pump (6), in particular the position of the furthest upstream active conveying element or the furthest upstream conveying active parts of the melt pump (6).

16. The device according to claim 1, characterized in that the ratio of the length of the section of the screw (10) between the first filtration unit (3) and the furthest upstream front degassing opening of the degassing zone (5) to the length of the section of the screw (10) between the furthest downstream degassing opening (11) of the degassing zone (5), and the extruder outlet (9), or to the length of the remaining screw (14), is in the range from 0.1 to 3, in particular in the range from 0.3 to 2.

17. The device according to claim 1, characterized in that the length of the section of the screw (10) between the first filtration unit (3) and the furthest upstream front degassing opening of the degassing zone (5) is in the range of 1 to 15 D, in particular in the range of 3 to 10 D.

18. The device-according to claim 1, characterized in that the lengths of the section of the screw (10) between the rearmost downstream degassing opening (11) of the degassing zone (5) and the extruder outlet (9), or the length of the remaining screw (14), is in the range from 3 to 12 D, in particular in the range from 4 to 10 D, preferably in the range from 5 to 8 D.

19. A method for processing materials containing or consisting of polymeric materials, preferably using the device according to claim 1, in particular for the recycling processing of contaminated thermoplastic polymers, comprising the following processing steps in the specified order:
a) feeding of the materials to be processed, in particular in a container,
b) at least partially, in particular completely, melting of the materials, in particular in an extruder,
c) first filtration of the melt to release non-melted components and/or impurities,
d) degassing of the filtered melt,
e) increasing of the pressure of the melt by a melt pump,
f) discharge and/or subsequent processing of the melt,
characterized in that the increase in the pressure of the melt is connected downstream of the degassing of the melt and is process-coupled one after the other.

20. The method according to claim 19, characterized in that after the first filtration of the melt according to step c) and prior to the degassing of the melt according to step d), the filtered melt is homogenized.

21. The method according to claim 19, characterized in that after the increase in pressure of the melt according to step e), the melt is filtered a second time, in particular immediately and directly, without any further intermediate processing step.

22. The method according to claim 19, characterized in that the materials are crushed and/or heated prior to melting according to step b), in particular during step a), wherein it is preferably provided that the materials are permanently mixed while retaining their lumpiness and flowability, and optionally degassed, softened, dried, increased in viscosity, and/or crystallized.

23. The method according to claim 19, characterized in that at least the processing steps b), d), and e), in particular all provided processing steps, follow one another directly and immediately, in each case without any further processing step in between.

24. The method according to claim 19, characterized in that the melt pump (6) is connected at a distance (13) of <=20 D, in particular in the range of 5 to 15 D, preferably in the range of 5 to 20 D, preferably 8 to 11 D, wherein D is the outer diameter of the screw (10) of the extruder (2) measured at the rearmost degassing opening (11) of the degassing zone (5) located furthest downstream in the conveying direction, and where the distance (13) is defined as the distance measured between the center of the rearmost degassing opening (11) of the degassing zone (5) located furthest downstream in the conveying direction and the melt pump (6), in particular the position of the active conveying element located furthest upstream or of the active conveying parts of the melt pump (6) located furthest upstream.

25. The method according to claim 19, characterized in that the inner core cross-section of the screw (10), the slope of the screw (10), and/or the product is designed in terms of depth, web width, thread width and thread slope of the screw (10) in the area between the center of the rearmost degassing opening (11) of the degassing zone (5) and the extruder outlet (9) located furthest downstream in the conveying direction.
